(19) United States
(12) Patent Application Publication
(10) Pub. No.: US 2017/0148089 A1
(43) Pub. Date: May 25, 2017

(54) Live Dressing Room

(71) Applicant: Yuri Murzin, West Springfield, MA (US)

(72) Inventor: Yuri Murzin, West Springfield, MA (US)

(21) Appl. No.: 14/951,817

(22) Filed: Nov. 25, 2015

(51) Int. Cl. G06Q 30/06; G06F 3/0488; G06K 9/00; G06F 3/0484; G06T 19/00; G06T 13/40

(52) U.S. Cl. CPC G06Q 30/0643; G06T 19/00; G06T 13/40; G06K 9/00302; G06F 3/04842; G06F 3/0488; G06T 2200/04

(57) ABSTRACT

Disclosed herein is a method and apparatus that will allow customers to virtually try on articles of clothing by presenting a mirrored display that allows for the garment to be displayed on the reflection of the user, thereby providing a means to see the article as it would appear if they were to wear it, eliminate the mess that may arise in the store's dressing rooms, help to prevent shoplifting, and increase sales of merchandise. Furthermore, the method accurately specifies the fitting of garments, and matches well-fitting garments with individual consumers, wherein the method provides means to keep dressing rooms clean, allow the user to see the merchandise as how it would look on them, prevent theft, and increase the sale of merchandise.

### CROSS REFERENCE TO RELATED APPLICATIONS

Not applicable

### FEDERALLY SPONSORED RESEARCH AND DEVELOPMENT

Not applicable.

### MICROFICHE

Not applicable

### BACKGROUND OF THE INVENTION

Field of the Invention

The present invention generally relates to selling products. More specifically, a the invention relates to a method to present articles of clothing, jewelry, or accessories to a user through means of a mirrored display device where the user can see their appearance while simulating wearing the articles of apparel on the reflection of the user.

Background of the Invention

With the rise of the Internet and constant upgrades to technology, consumer demand for new products only increases. People no longer have to shop in local brick and mortar stores to acquire the goods they want. Online shopping allows a user to purchase goods at a greater convenience. However, for the clothing industry, it is still necessary for consumers to try clothing themselves to see how it fits since templates and methods of cutting may differ from company to company. Typically tried for fit in the store, the clothing a user may want to try on or purchase may not be in stock, the right size, or the right color for the consumer. Sometimes, when users do not wish to purchase the items, the articles of clothing are left in the dressing room for the employees to return to the floor or stock room. Leaving the clothing in the dressing room creates a mess for other customers if the employees are unable to get to the dressing rooms to clean the mess left behind. Some disreputable consumers even use the changing room as a means to shoplift and steal items from the store. Due to this, some establishments have introduced policies to limit the number of clothing or apparel articles that may be taken into the dressing room or provide a number that equates to the number of articles the consumer wishes to try on that must be returned when the consumer exits the dressing room. Consumers may still purchase clothing online for a larger variety of colors and styles, but at risk of the garment being cut differently due to differing manufacturing processes and clothing templates, therefore creating the possibility that the clothing will not fit the buyer.

A number of different types of applications and devices are available in the prior art to address this problem, such as:

U.S. Patent No. 20140035913 A1 to Ebay Inc., which shows a method and system that are provided to facilitate recognition of gestures representing commands to initiate actions within an electronic marketplace on behalf of a user. An action machine receives spatial data about an environment external to a depth sensor, and then generates a first model of a body of the user based on a first set of spatial data received at a first time. The action machine may then generate a second model of the body of the user based on a second set of spatial data received at a second time. The action machine may further determine that a detected difference between the first and second models corresponds to a gesture by the user, and that this gesture represents a command by the user to initiate an action within the electronic marketplace on behalf of the user.

U.S. Patent No. 20140129370 A1 to James L. Mabrey, which shows a software application that provides a social, interactive panoramic shopping experience from pictures along with being able to reconfigure parts of the image based on a Chroma key color.

U.S. Patent Application No. 20140282137 A1 to Yahoo! Inc., which shows an image of a subject that is received along with viewable representations of a user, with the selected wearable object having a respective size indicative of the physical dimensions of the wearable object. The physical proportions of the subject are determined, and a display is generated that shows how the wearable object will look when worn by the subject.

U.S. Pat. No. 5,680,528 A to Korszun; Henry A., which shows a system of software programs and a database of digital images, including garment images and a basic model body image, which allows a client to select and “try on,” either individually or by mixing and matching, the different garment images of the database. The system renders an image of the client's body in the garments, with the client's specific curves, bulges, and height reflecting the client's actual body measurements. Broadly, the system is comprised of two parts: a preprocess and an online process.

U.S. Pat. No. 6,307,568 B1 to Imaginarix Ltd., which shows a method and system for displaying garments over the Internet as though the garments were being draped over the body of a user. The method and system of the present invention fits articles of clothing to an image of a user over the Internet. The image of the user is derived from a picture of the user. Critical points are taken from the image of the user, and are used to adjust the spatial configuration of the clothing. The critical points within the volume of the article of clothing are adjusted to match the critical points of the image of the body of the user such that the spatial configuration of the article of clothing matches the configuration that would be adopted if the user was actually wearing the article of clothing. The adjusted garment image is combined with the user image and is displayed.

None of the above inventions and patents, taken either singly or in combination, is seen to disclose an invention with an objective to provide a method and apparatus that will allow customers to virtually try on articles of clothing by presenting a mirrored display that allows for the garment to be displayed on the reflection of the user, thereby providing a means to see the article as it would appear if they were to wear it, eliminate the mess that may arise in the store's dressing rooms, help prevent shoplifting, and increase sales of merchandise. The invention may be used in a traditional brick and mortar store, or purchased for home use.

### SUMMARY OF THE INVENTION

The primary objective of the present invention is to provide a method and system to more accurately specify the fit of garments and to match well-fitting garments with individual consumers. The method provides means to keep dressing rooms clean, allow the user to see the merchandise as how it would look on them, prevent theft, and increase the sale of merchandise.

In a preferred embodiment, the invention provides a method of receiving an image of the user's body from a plurality of image-capture components, wherein the image-capture components are placed in a manner to capture a 360° view of the user. The system then constructs a movable, three-dimensional, virtual avatar to substantially resemble the user, wherein the virtual avatar is displayed over at least one display. The method also obtains data that identifies the wearable item selected for the user. The data includes a plurality of metrics that at least partly define the wearable item, wherein the wearable item is displayed over at least one display.

According to another embodiment of the invention, the image-capture components are cameras, which are placed in manner to capture all possible views of the user. The avatar is displayed on the display of a computing device. Also, the display serves as a reflecting surface.

Furthermore, the wearable item is selected for the user via an input device with the display displaying the wearable item, wherein the display displaying the wearable item is a computing device and the display is touch enabled.

In yet another embodiment, the wearable item is selected via the display displaying the wearable item upon inputting the unique id of the wearable item.

In another embodiment, the invention includes a method to receive an image of the user while wearing the wearable item and save that image for the user to review, and a means to recognize the user's facial reaction to suggest the level of like or dislike of the wearable item.

The summary is provided to introduce a selection of concepts, in a simplified form, that are further described below in the detailed description. This summary is not intended to identify key features or essential features of the subject matter, nor is it intended to be used as an aid in determining the scope of the subject matter. In this respect, before explaining at least one embodiment of the invention in detail, it is to be understood that the invention is not limited in its application to the details of construction and to the arrangements of the components set forth in the following description or illustrated in the drawings. The invention is capable of other embodiments, and of being practiced and carried out in various ways. Also, it is to be understood that the phraseology and terminology employed herein are for the purpose of description, and should not be regarded as limiting. These, together with other objectives of the invention and the various features of novelty that characterize the invention, are pointed out with particularity in the disclosure. For a better understanding of the invention, its operating advantages, and the specific objectives attained by its uses, reference should be had to the accompanying descriptive matter, in which there are illustrated preferred embodiments of the invention.

### BRIEF DESCRIPTION OF THE DRAWINGS

To further clarify various aspects of some example embodiments of the present invention, a more particular description of the invention will be rendered by reference to specific embodiments thereof, which are illustrated in the appended drawing. It is appreciated that the drawing depicts only illustrated embodiments of the invention, and is, therefore, not to be considered limiting of its scope. The invention will be described and explained with additional specificity and detail through the use of the accompanying drawing, in which:

FIG. 1 is perspective view of the present invention.

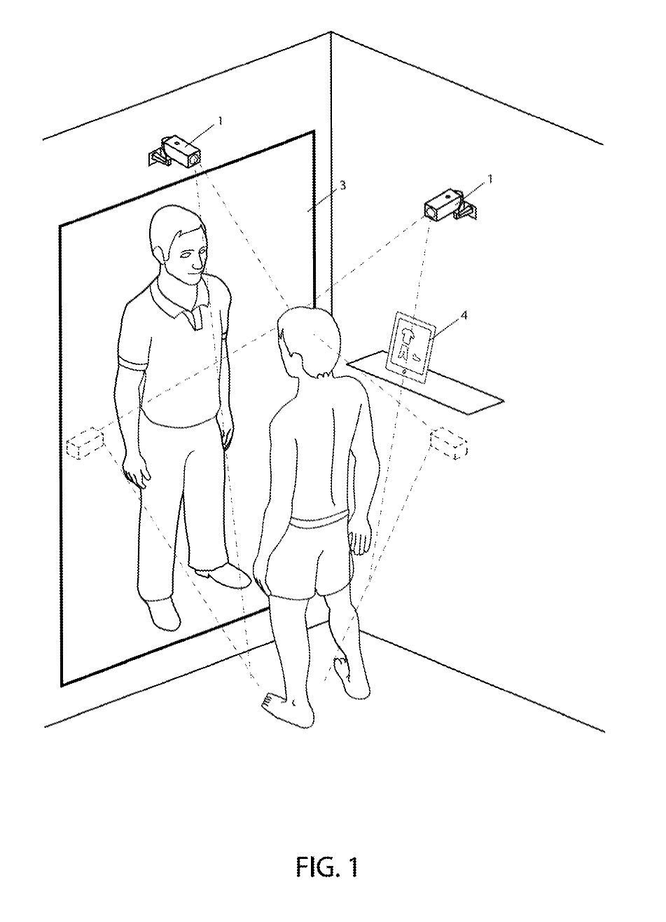

### DETAILED DESCRIPTION OF THE INVENTION

The following is a detailed description of example embodiments of the invention that is depicted in the accompanying drawings. The example embodiments are in such detail as to clearly communicate the invention. However, the amount of detail offered is not intended to limit the anticipated variations of embodiments. On the contrary, the intention is to cover all modifications, equivalents, and alternatives falling within the spirit and scope of the present invention. The detailed descriptions below are designed to make such embodiments obvious to a person of ordinary skill in the art.

The present invention can be implemented on any communication device that has hardware components that can perform wireless and wired communication, such as (but not limited to) desktop computers, multi-purpose pocket computers, cellular telephones, personal multimedia devices, etc.

The various devices on which the applications that implement the present invention run may use one or more processors with different instruction sets, architectures, clock-speeds, etc., and memory that may include high speed random access memory and may include non-volatile memory, such as one or more magnetic disk storage devices, flash memory devices, and other kinds of solid state memory devices.

The various applications that can implement the present invention run on electronic devices that may use at least one physical user interface device that provide the means of control and navigation within the operating system. Applications that run on the devices include (but are not limited to) touch-pads, such as those described in (but not limited to)—(1) U.S. patent application Ser. No. 10/722,948 (“Touch pad for handheld device”, filed Nov. 25, 2003) ;(2) U.S. patent application Ser. No. 10/188,182 (“Touch pad for handheld device”, filed Mar. 21, 2006) ;(3) U.S. patent application Ser. No. 08/210,610 (“Computer system with touchpad support in operating system”, filed Mar. 18, 1994); (4) U.S. patent application Ser. No. 643,256 (“Movable touch pad with added functionality”, filed Ser. No. 10/643,256), touch screens such as those described in(but not limited to) (1) U.S. patent application Ser. No. 11/381,313, “Multipoint Touch Surface Controller,” filed on May 2, 2006; (2) U.S. patent application Ser. No. 10/840,862, “Multipoint Touchscreen,” filed on May 6, 2004; (3) U.S. patent application Ser. No. 10/903,964, “Gestures For Touch Sensitive Input Devices,” filed on Jul. 30, 2004; (4) U.S. patent application Ser. No. 11/048,264, “Gestures For Touch Sensitive Input Devices,” filed on Jan. 31, 2005; (5) U.S. patent application Ser. No. 11/038,590, “Mode-Based Graphical User Interfaces For Touch Sensitive Input Devices,” filed on Jan. 18, 2005; (6) U.S. patent application Ser. No. 11/228,758, “Virtual Input Device Placement On A Touch Screen User Interface,” filed on Sep. 16, 2005; (7) U.S. patent application Ser. No. 11/228,700, “Operation Of A Computer With A Touch Screen Interface,” filed on Sep. 16, 2005; (8) U.S. patent application Ser. No. 11/228,737, “Activating Virtual Keys Of A Touch-Screen Virtual Keyboard,” filed on Sep. 16, 2005 and (9) U.S. patent application Ser. No. 11/367,749, “Multi-Functional Hand-Held Device,” filed on Mar. 3, 2006, click wheels, such as those described in U.S. patent application Ser. No. 11/549,619 “Method, device, and graphical user interface for dialing with a click wheel” filed on Oct. 13, 2006, keyboards, such as those mentioned in (but not limited to) U.S. patent application Ser. No. 07/711,760 (“Ergonomic keyboard input device”, filed on Jun. 6, 1991), mouse, such as those described in (but not limited to) (1) application Ser. No. 09/167,314 (“Computer mouse with enhance control button(s)”, filed on Oct. 6, 1998); (2) application Ser. No. 08/288,945 (“Roller mouse for implementing scrolling in windows applications”, filed on Aug. 10, 1994) and gesture recognition means, such as those described in(but not limited to) (1) European Patent application publication number: EP2482176 A2 (“Multi-input gesture control for a display screen”, filed on Nov. 4, 2011) and(2) U.S. Patent application with publication number 20120317511 A1 (“DISPLAY WITH BUILT IN 3D SENSING CAPABILITY AND GESTURE CONTROL OF TV”, filed on Aug. 21,2012).

The display means used by these devices may use LCD (liquid crystal display) technology, LED (light Emitting Diode) technology, CRT (Cathode ray tube) technology, LPD (light emitting polymer) technology, or any other display technologies. Various realizations of graphics display circuitry that implement a Graphics Processing Unit (GPU) are used to achieve video interface between user and these electronic devices.

Connectivity of these devices with networks, such as the Internet, an intranet and/or wireless network, such as cellular telephone network, a wired or wireless local area network (LAN) and/or metropolitan area network (MAN) and/or WAN (wide area network), and other wireless communication, is achieved by use of a plurality of communication standards, protocols, and technologies such as Bluetooth, Wireless

Fidelity (Wi-Fi), and/or any other suitable communication protocols, including communication protocols not yet developed as of the filing date of this document.

The present invention may be implemented on applications that run on a single or variety of operating system platforms, including but not limited to OS X, WINDOWS, UNIX, IOS, ANDROID, SYMBIAN, LINUX, or embedded operating systems, such as VxWorks.

The present invention may also be implemented to work with various web browsers, including but not limited to Internet Explorer, Mozilla Firefox, Safari, and Opera, which access and handle various types of webpages constructed with various mark-up languages, such as HTML, HTML-5, XHTML, XML, etc., and the associated CSS (cascading style sheet) files and java-script files.

With the rise of Internet consumerism and the increases of technology in recent years, there is room for progress to be made with traditional brick and mortar apparel establishments. Currently, consumers have to travel to a clothing store to physically try on clothing to ensure that the purchased items will fit properly when worn. Clothing can be purchased through various websites on the Internet; however, due to different templates and techniques of cutting materials, which are sewn into the articles of clothing, the purchased article may not fit the consumer. The present invention seeks to eliminate the shortcomings of the previous methods of purchasing merchandise and trying out merchandise before purchasing. It is an objective of this invention to provide a means to keep dressing rooms clean, allow the user to see the merchandise as how it would look on them, prevent theft, and increase the sale of merchandise. In order to accomplish these objectives, a plurality of cameras is to be used to record a person in front of a display device that would display a selected article of clothing on the user as it would be worn on the user. The consumer will be able to walk into a dressing room and remove their clothes as normal. They will then enter or scan the code, using a touch pad or scanner, corresponding to the clothing, jewelry, or accessory they wish to be presented to them. Through use of a computer algorithm and the imaging from the cameras, the selected article would be placed on the reflection of the user to display the article as the user would wear it. The invention is comprised of a display device, a plurality of cameras, and a computing device.

Referring to the drawing, specifically to FIG1 thereof, the receiving of an image of the user's body from a plurality of image-capture components 1 is illustrated, wherein the image-capture components 1 are placed in a manner to capture a 360° view of the user. Based on the image, the device constructs a movable, three-dimensional virtual avatar 2 to substantially resemble the user, wherein the virtual avatar is displayed over at least one display 3. The devices obtains data that identifies the wearable item 4 from the user, The data includes a plurality of metrics that at least partly define the wearable item , wherein the wearable item is displayed over at least one display .

According to another embodiment of the invention, the image-capture components 1 are cameras that are placed in a manner to capture all possible views of the user. The avatar is displayed on the display of a computing device. The display also serves as a reflecting surface.

Furthermore, the wearable item is selected by the user via an input device, with the display displaying the wearable item. The display that displays the wearable item is a computing device, and the display is touch enabled.

In yet another embodiment, the wearable item is selected via the display displaying the wearable item upon inputting the unique id of the wearable item 3.

In another embodiment, the invention includes a method to receive an image of the user while wearing the wearable item and save that image for the user to review and a means to recognize the user's facial reaction to suggest the level of like or dislike of the wearable item .

The display 3 is comprised of the plurality of cameras and a user interface. The display may include an LCD or LED monitor for the user interface and receives an input from the computing device to display the selected article of clothing on the user. The display would be sized as a traditional mirror in a dressing room would be sized, and placed similarly onto the wall of the dressing room. The user can input the code that corresponds to the article to be displayed using the touch screen capabilities of the user interface presented on the display or touch pad. In an alternate embodiment, a scanning device may be included alongside the display device to allow the user to scan the barcode of the product. The computing device would then access the proper article based on the pattern of the barcode. Cameras are to be mounted at the corners of the display device to record the user. The cameras will output the images or video of the user to the computing device. In another alternate embodiment, the display device may have a mirrored display, where the device may function as a traditional mirror as well as display articles of clothing as presented in the preferred embodiment. In this embodiment, the cameras may be mounted behind the mirror with a one-way mirror surface covering them, so that they are invisible to the naked eye but will allow the recording of the user.

In addition to the display 3, the invention also consists of a computing device. The computing device is comprised of a complex algorithm that receives inputs from the cameras and the user interface. Upon receiving the code from the user, the computer accesses a database or images on the Internet in order to output and display the corresponding article of apparel onto the user on the display device. Clothing and other apparel may be separated into various categories, such as color, season, or occasion. Based on the category of the apparel selected, the program may display a background. For example, if the user picks up a Hawaiian shirt, the background may change to an ocean shore, or if the user wishes to purchase a winter hat, the background may change to a snow covered forest. The algorithm may further suggest additional apparel that is available in the store. For example, if the user picked that Hawaiian shirt, the program may suggest a pair of shorts that would match or compliment the shirt. If a female user selected an evening dress, a necklace or earrings may be suggested. Using facial and emotional recognition software, the program may determine if the user likes the article of apparel, and may even compliment the user if a smile is detected or suggest another article if the user presents dislike for the first item. Other possible suggestions the program may make include make-up, handbags, scarves, or other accessories. The program would have access to every item in the store and the variations of the items that the suppliers may have. If the article the user has selected is out of stock for that size or color, the user can order the article they desire and have it delivered to their home, increasing sales and customer satisfaction for the store.

Additionally, the invention in its preferred embodiment will help to prevent theft by limiting or eliminating the need to physically bring the article of apparel into the dressing room. The user simply needs a code or to browse the database of store to find apparel that they may want to try on and, once selected, the program would display that article on the user. By not having the user need to physically bring in the articles of clothing, the dressing room space may be kept cleaner, thereby relieving the staff from this duty to focus on other tasks. The presented invention has applications all over the store, and is not simply restricted to the dressing room. For example, the present invention may be used in the jewelry section of the store, allowing users to preview how the jewelry would look on them without having to find a sales representative to open the secured case and jeopardize the merchandise.

Although specific embodiments have been illustrated and described herein, it will be appreciated by those of ordinary skill in the art that any arrangement that is calculated to achieve the same purpose may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

1. A system/method to facilitate visualization of how a wearable item would look on a user's body in a fitting/ trial room using a combination of electronic devices, said system/method comprising:
receiving an image of the user's body from a plurality of image-capture components, wherein said image-capture components are placed in a manner to capture a 360° view of said user;
constructing a movable, three-dimensional virtual avatar to substantially resemble the user based on the image, wherein said virtual avatar is displayed over at least one display;
obtaining data that identifies the wearable item selected by the user, the data including a plurality of metrics that at least partly define the wearable item, wherein said wearable item is displayed over at least one display;
attaching a virtualized form of the wearable item to the avatar; and
providing the avatar, with the virtualized form of the wearable item attached, to a display component for the user to review.

2. The method/system of claim 1, wherein constructing the avatar includes constructing a head-and-body model of the user based on the images captured from said image-capture components, and wherein the head-and-body model accurately represents the size and shape of the user's body.

3. The method/system of claim 1, wherein said avatar is displayed on said display of a computing device.

4. The method/system of claim 1, wherein said image-capture components are camera.

5. The method/system of claim 1, wherein said image-capture components are placed in a manner to capture all possible views of said user.

6. The method of claim 1 wherein said wearable item is selected for the user via an input device with said display displaying said wearable item.

7. The method of claim 1 wherein said wearable item is selected via said display displaying said wearable item on inputting a unique id of said wearable item.

8. The method of claim 1 wherein said display serves as a reflecting surface.

9. The method of claim 1 further comprising receiving an image of the user while wearing the wearable item and saving that image for the user to review.

10. The method of claim 1 further comprising of a means to recognize said user's facial reaction to suggest the level of like or dislike of said wearable item.

11. The method of claim 1 wherein said display displaying said wearable item is a computing device.

12. The method of claim 11, wherein said display displaying said wearable item is touch enabled.
